(19) United States
(12) Patent Application Publication
(10) Pub. No.: US 2012/0123598 A1
(43) Pub. Date: May 17, 2012

(54) VARIABLE FLOW CONTROL USING LINEAR PUMPS

(76) Inventors: Micheal A. Cryer, Massillon, OH (US); Michael J. Sebion, Apple Valley, MN (US)

(21) Appl. No.: 13/386,963

(22) PCT Filed: Jul. 27, 2010
(86) PCT No.: PCT/US10/43449

§ 371 Date: Jan. 25, 2012

Related U.S. Application Data
(60) Provisional application No. 61/229,347, filed on Jul. 29, 2009.

(51) Int. Cl. G05D 7/00

(52) U.S. Cl. 700/282

(57) ABSTRACT

Variable (10) and fixed ratio 100 dispensing systems are disclosed. Each pump (12) is powered by a DC motor (14) spinning a gear pump (16) which is immersed in a hydraulic power pack (18). The power pack 18 output feeds a hydraulic linear motor (20) where its direction is controlled by a two output reversing valve (22). The hydraulic linear motor (20) drives one or two material pumps (24) which are mechanically attached to the hydraulic pump (12). The pressure and/or flow outputs of the material pumps (24) are controlled by altering the torque output of the DC motor (14), using a custom designed motor control module (MCM) (26). The MCM (26) uses a linear position sensor (28) and a pressure transducer (30) installed at the output of the material pump (24) as primary process variables (or feedbacks) for the pump (24). The system not dependant upon expensive flow meters for controlling the pump output.

This application claims the benefit of U.S. Application Ser. No. 61/229,347, filed Jul. 29, 2009, the contents of which are hereby incorporated by reference.

### TECHNICAL FIELD

### Background Art

One of the issues when dispensing two component materials in a high-end system, is the need to maintain constant pressure during idle periods between dispense operations. In past practice, especially in RIM based (Reaction Injection Molding) dispensers, an automatic recirculation system was used. An automatic recirculation system requires the dispense pumps and conditioning systems to operate continuously.

### DISCLOSURE OF THE INVENTION

This method of the instant invention will eliminate the need of an automatic recirculation system, its cost and power requirements while providing similar results. In a fixed ratio system according to the invention, the following advantages are present: (1) pressure control: the pressure set point is maintained in both static and dynamic condition which eliminates static to dynamic pressure dead band; (2) flow rate control: the flow rate of a two component material is maintained to set point to ensure an accurate volumetric dispense rate; (3) change-over control: reduces volume loss during directional change (change over) for the linear piston pump—this loss during change over can create a loss in dispense volume; (4) material viscosity control: two independent heat controls for both the A and B side components manages material viscosity for dispense repeatability and through mix in the applicator; (5) applicator controls: assure all parameters are met before a material dispense is initiated.

Similarly, in a variable ratio system, the following advantages are present: (1) pressure control: pressure set point is maintained in both static and dynamic conditions which eliminates static to dynamic pressure dead band; (2) flow rate control: the flow rate of a two component material is maintained to set point to ensure both an accurate volumetric mix ratio and dispense rate; (3) change over control: reduces volume loss during directional change (change over) for the linear piston pump—this loss during change over can create a loss in dispense volume; (4) material viscosity control: two independent heat controls for both the A and B side components manages material viscosity for dispense repeatability and through mix in the applicator; (5) applicator controls: assure all parameters are met before a material dispense is initiated; and (6) synchronized pump control: none phase shifted pump control.

The following disclosure is based on the system block diagram of FIG. 1. The diagram illustrates a full variable ratio system. The general design can be used for both variable and fixed ratio dispensing systems.

As indicated in the figure, each pump is powered by a DC motor spinning a gear pump which is immersed in a hydraulic power pack. The power pack output feeds a hydraulic linear motor where its direction is controlled by a two output reversing valve. The hydraulic linear motor drives one or two material pumps which are mechanically attached to the hydraulic pump.

The pressure and/or flow outputs of the material pumps are controlled by altering the torque output of the DC motor, using a custom designed motor control module (MCM). The MCM uses a linear position sensor and a pressure transducer installed at the output of the material pump as the primary process variables (or feedbacks) for controlling the pump. The system is not dependant upon expensive flow meters for controlling the pump output.

The two MCM's will be installed to control two pumps independently. In this configuration, the two MCM's will communicate with each other to provide a true variable ratio system for the user.

To eliminate the need for expensive automatic recirculation components, this system will stall to a set pressure entered by the user. Stalling to pressure is the process of operating the motor and pump(s) to a low torque level with the dispense valve(s) closed. When in this mode, the small levels of torque applied to the motor are only required to maintain the requested target pressure.

Implementing this practice will save considerable power, hence eliminating the need to operate the pumps continuously during the idle non-dispense periods, plus will eliminate the need to operate the material conditioning system. Stalling to a set pressure will help ensure the material dispensed from the material applicator is at the desired pressure at the start of the dispense operation.

The system will stall at pressure after a dispense operation to the target pressure set during the last dispense operation. This will remain during an idle situation between dispenses.

When a new dispense operation is instigated, a new target pressure for the dispense will entered into the pressure control logic (replacing the older target pressure), prior to the dispense start. If the idle stalled condition described previously remains for an extended period of time, the “stall to pressure” condition will be terminated. The finite limit for allowing the “stalled to pressure” condition to exist is to save power, reduce heat in the hydraulic power pack and other mechanical components.

The following advantages apply to the system configured without an automatic recirculation system:
The invention eliminates the need of automatic recirculation valves, logic and associated recirculation tubing.
The invention eliminates the need operating the conditioning system at dispense levels, hence saving significant power to operate the machine.
Since the pumps will not significantly operate during idle periods, less wear on the mechanical components is expected.

In the variable ratio dispense configuration, the user can select to dispense 2 part material at a constant flow rate. The MCM will take the flow rate requested by the user (in units of volume over time increments for the mixed 2 part material), and use the following items to mathematically convert the information into target piston velocities for each pump in the system:

1. Size of the A and B pumps.

2. Ratio for the material entered by the user.

Controlling the flow rate of the material dispensed is done by controlling the pump pressure and pump velocity. Velocity is calculated by the MCM logic, by calculating the change in pump position at a fixed interval of time.

The existing MCM logic will control flow by maintaining piston velocity between pump reversals with either a single velocity PID logic loop, or 2 cascaded PID loops with the top velocity control loop having its control output feeding a lower pressure control loop with pressure set points. If operating at low dispense pressures, a pump velocity only control loop may be used.

To minimize system cost, the flow control logic does not need the input of an expensive flow meter for monitoring the flow output of the pump. For the system, a separate optional flow monitoring module may be used for verifying the flow output of the pump. The separate optional system uses flow meters installed in the material flow path to verify flow output of the system.

The MCM will be responsible for monitoring and tracking whether the target velocity of the pump has been achieved, after each velocity calculation of the pump. If the logic was NOT able to maintain its target velocity (within a certain percentage of the target) for the large percentage of the dispense operation, a corresponding off ratio or off flow error code will be generated.

When dispensing at a constant flow on a variable ratio system, the following items apply:

a. When dispensing 2 components which need to have the ratio of the final mixed material at the same ratio for the entire duration of the dispense operation, both pumps will operate in a synchronized mode. In other words, both pumps must reverse at the same time to duplicate the pressure drop in both pumps simultaneously to better ensure that an “on ratio condition” does NOT exist during the pump reversing process. This process may not be necessary for some 2 component materials.

b. To control the ratio of the 2 pumps, both pumps must maintain their respective pump velocities a high percentage of time during the dispense operation. For example, to dispense at a 2:1 ratio for 2 pumps of the same size, the pump velocity of one pump needs to be 2 times faster than the 2nd pump. For this type of dispense, the slower synchronized pump will be “short stroked” (will not travel the entire pump length) as set forth above.

The following advantages apply to the system of variable ratio control:

1. The invention allows the use of linear pumps, which are cheaper and will dispense a larger variety of materials. Using rational gear pumps for variable ratio dispensing applications is more expensive, and does not work very well when dispensing high viscosity or abrasive materials.

2. The invention does not require expensive flow meters for controlling flow for the user.

3. The invention allows the user to alter the flow rate and dispense ratio without changing any mechanical settings.

4. The invention allows the user to alter the flow rate and dispense ratio during an active dispense operation.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a variable ratio system according to the instant invention.

FIG. 2 shows a fixed ratio system according to the instant invention.

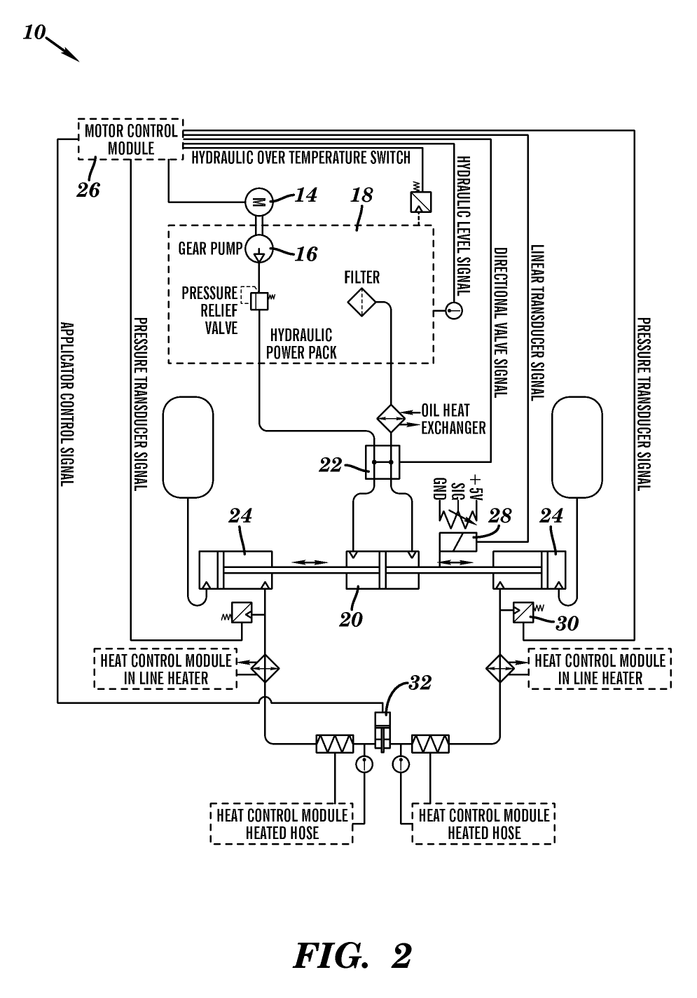

### BEST MODE FOR CARRYING OUT THE INVENTION

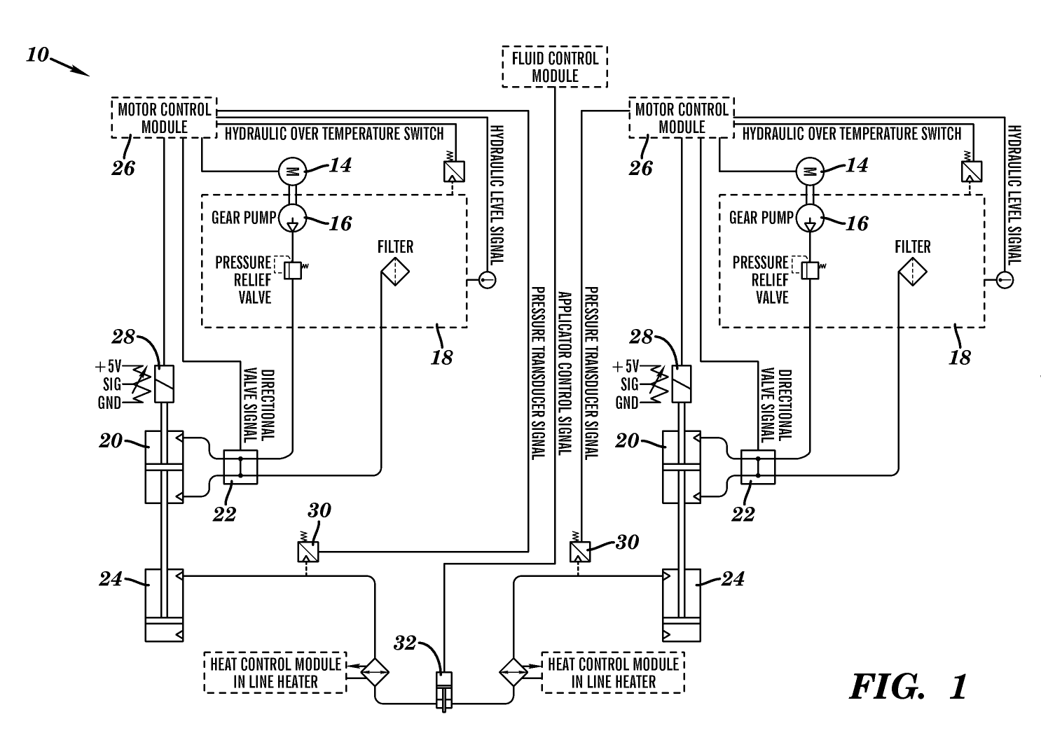

The following disclosure is based on the system block diagram of FIG. 1. The diagram illustrates a full variable ratio system 10. The general design can be used for both variable 10 and fixed ratio 100 dispensing systems.

As indicated in the figure, each pump is powered by a DC motor 14 spinning a gear pump 16 which is immersed in a hydraulic power pack 18. The power pack 18 output feeds a hydraulic linear motor 20 where its direction is controlled by a two output reversing valve 22. The hydraulic linear motor 20 drives one or two material pumps 24 which are mechanically attached to the hydraulic pump 12.

The pressure and/or flow outputs of the material pumps 24 are controlled by altering the torque output of the DC motor 14, using a custom designed motor control module (MCM) 26. The MCM 26 uses a linear position sensor 28 and a pressure transducer 30 installed at the output of the material pump 24 as the primary process variables (or feedbacks) for controlling the pump 24. The system is not dependant upon expensive flow meters for controlling the pump output.

The two MCM's 26 will be installed to control two pumps 24 independently. In this configuration, the two MCM's 26 will communicate with each other to provide a true variable ratio system for the user.

To eliminate the need for expensive automatic recirculation components, this system will stall to a set pressure entered by the user. Stalling to pressure is the process of operating the motor 14 and pump(s) 24 to a low torque level with the dispense valve(s) 32 closed. When in this mode, the small levels of torque applied to the motor 14 are only required to maintain the requested target pressure.

Implementing this practice will save considerable power, hence eliminating the need to operate the pumps 24 continuously during the idle non-dispense periods, plus will eliminate the need to operate the material conditioning system. Stalling to a set pressure will help ensure the material dispensed from the material applicator 32 is at the desired pressure at the start of the dispense operation.

The system will stall at pressure after a dispense operation to the target pressure set during the last dispense operation. This will remain during an idle situation between dispenses.

When a new dispense operation is instigated, a new target pressure for the dispense will entered into the pressure control logic (replacing the older target pressure), prior to the dispense start. If the idle stalled condition described previously remains for an extended period of time, the “stall to pressure” condition will be terminated. The finite limit for allowing the “stalled to pressure” condition to exist is to save power, reduce heat in the hydraulic power pack and other mechanical components.

In the variable ratio dispense configuration, the user can select to dispense 2 part material at a constant flow rate. The MCM will take the flow rate requested by the user (in units of volume over time increments for the mixed 2 part material), and use the following items to mathematically convert the information into target piston velocities for each pump in the system:

1. Size of the A and B pumps.

2. Ratio for the material entered by the user.

Controlling the flow rate of the material dispensed is done by controlling the pump pressure and pump velocity. Velocity is calculated by the MCM logic, by calculating the change in pump position at a fixed interval of time.

The existing MCM logic will control flow by maintaining piston velocity between pump reversals with either a single velocity PID logic loop, or 2 cascaded PID loops with the top velocity control loop having its control output feeding a lower pressure control loop with pressure set points. If operating at low dispense pressures, a pump velocity only control loop may be used.

To minimize system cost, the flow control logic does not need the input of an expensive flow meter for monitoring the flow output of the pump. For the system, a separate optional flow monitoring module may be used for verifying the flow output of the pump. The separate optional system uses flow meters installed in the material flow path to verify flow output of the system.

The MCM will be responsible for monitoring and tracking whether the target velocity of the pump has been achieved, after each velocity calculation of the pump. If the logic was NOT able to maintain its target velocity (within a certain percentage of the target) for the large percentage of the dispense operation, a corresponding off ratio or off flow error code will be generated.

When dispensing at a constant flow on a variable ratio system, the following items apply:

a. When dispensing 2 components which need to have the ratio of the final mixed material at the same ratio for the entire duration of the dispense operation, both pumps will operate in a synchronized mode. In other words, both pumps must reverse at the same time to duplicate the pressure drop in both pumps simultaneously to better ensure that an “on ratio condition” does not exist during the pump reversing process. This process may not be necessary for some 2 component materials.

b. To control the ratio of the 2 pumps, both pumps must maintain their respective pump velocities a high percentage of time during the dispense operation. For example, to dispense at a 2:1 ratio for 2 pumps of the same size, the pump velocity of one pump needs to be 2 times faster than the 2nd pump. For this type of dispense, the slower synchronized pump will be “short stroked” (will not travel the entire pump length) as set forth above.

The following advantages apply to the system of variable ratio control:

It is contemplated that various changes and modifications may be made to the flow control system without departing from the spirit and scope of the invention as defined by the following claims.

1. A variable flow plural component dispensing system, said dispensing system comprising:
first and second hydraulic pumps;
a DC motor powering each said hydraulic pump;
a two output reversing valve at least one hydraulic linear motor having its direction is controlled by said reversing valve;
a first motor control module; and
at least one or material pump, said material pump having pressure and flow outputs and being mechanically attached to said hydraulic linear motor, one of said outputs being controlled by altering the torque output of said DC motor with said motor control module.

2. The variable flow plural component dispensing system of claim 1 further comprising a linear position sensor and a pressure transducer installed at the output of said material pump.

3. The variable flow plural component dispensing system of claim 2 further comprising a second motor control module wherein said first and second motor control modules control said first and second material pumps independently.

4. The variable flow plural component dispensing system of claim 3 wherein said first and second motor control modules communicate with each other to provide a true variable ratio system.

5. The variable flow plural component dispensing system of claim 1 wherein said motor control modules will stall to a set pressure entered by the user.

6. The variable flow plural component dispensing system of claim 5 wherein small levels of torque are applied to said motor to maintain the requested target pressure.
